(19) United States
(12) Patent Application Publication
(10) Pub. No.: US 2014/0150452 A1
(43) Pub. Date: Jun. 5, 2014

(54) TRANSITION PIECE FOR A GAS TURBINE SYSTEM

(71) Applicant: General Electric Company, Schenectady, NY (US)

(72) Inventors: John Frederick Pohlman, Greenville, SC (US); Daniel Doyle Vandale, Greenville, SC (US); Sergey Victorovich Koshevets, Moscow (RU); Mehmet Tartan, Greenville, SC (US); Carey Edward Romoser, Simpsonville, SC (US)

(73) Assignee: General Electric Company, Schenectady, NY (US)

(21) Appl. No.: 13/991,419

(22) PCT Filed: Nov. 30, 2012
(86) PCT No.: PCT/RU2012/001002

§ 371 Date: Jan. 20, 2014

(51) Int. Cl. F02C 7/20

(52) U.S. Cl. CPC F02C 7/20
USPC 60/796

(57) ABSTRACT

A system includes a gas turbine transition piece. The gas turbine transition piece includes a duct body having a forward end portion and an aft end portion. The duct body defines an enclosure for routing a flow of combustion products from a combustor to a turbine first stage nozzle, and the forward end portion includes a straight portion extending in a downstream direction of the flow. The gas turbine transition piece also includes a first set of dilution holes formed in the forward end portion and arranged in a first pattern configured to reduce emissions. In certain embodiments, the gas turbine transition piece includes a second set of dilution holes formed in the aft end portion and arranged in a second pattern configured to alter the thermal gradient of the combustion gases.

### CROSS-REFERENCE TO RELATED APPLICATION

This application claims priority to and the benefit of PCT Patent Application No. PCT/RU2012/001002, entitled “TRANSITION PIECE FOR A GAS TURBINE SYSTEM”, filed Nov. 30, 2012, which is herein incorporated by reference in its entirety.

### BACKGROUND OF THE INVENTION

The subject matter disclosed herein relates to gas turbines and, more particularly, to a transition piece for gas turbines.

Gas turbine engines may include one or more combustors each having a transition piece that connects each respective combustor to the turbine. As an air-fuel mixture combusts inside of the combustor, an increase in temperature within the transition piece may increase undesirable exhaust emissions (e.g., nitrogen oxides and carbon monoxide). In addition, the distribution of hot combustion gases may lead to thermal stress on downstream turbine components and accelerated hardware wear.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a gas turbine transition piece. The gas turbine transition piece includes a duct body having a forward end portion and an aft end portion. The duct body defines an enclosure for routing a flow of combustion products from a combustor to a turbine first stage nozzle, and the forward end portion includes a straight portion extending in a downstream direction of the flow. The gas turbine transition piece also includes a first set of dilution holes formed in the forward end portion and arranged in a first pattern configured to reduce emissions.

In accordance with a second embodiment, a system includes a gas turbine transition piece. The gas turbine transition piece includes a duct body having a forward end portion and an aft end portion. The duct body defines an enclosure for routing a flow of combustion products from a combustor to a turbine first stage nozzle. The gas turbine transition piece also includes a first set of dilution holes formed in the forward end portion and arranged in a first pattern configured to reduce emissions. The gas turbine transition piece further includes a second set of dilution holes formed in the aft end portion and arranged in a second pattern configured to alter the thermal gradient of the flow. At least some of the dilution holes of both the first and second sets of dilution holes are formed in the duct body at locations defined by selected X, Y, and Z coordinate sets listed in Table 1, wherein the coordinate sets are measured from a zero reference point at a center of an exit plane of the gas turbine transition piece.

In accordance with a third embodiment, a system includes a gas turbine transition piece. The gas turbine transition piece includes a duct body having a forward end portion and an aft end portion. The duct body defines an enclosure for routing a flow of combustion products from a combustor to a turbine first stage nozzle. The gas turbine transition piece also includes a first set of dilution holes formed in the forward end portion and arranged in a first pattern configured to reduce emissions. The gas turbine transition piece further includes a second set of dilution holes formed in the aft end portion and arranged in a second pattern configured to alter the thermal gradient of the flow. The first set of dilution holes includes 3 dilution holes and the second set of dilution holes includes 6 dilution holes. The first and second sets of dilution holes are formed in the duct body at locations defined by selected X, Y, and Z coordinate sets listed in Table 1, wherein the coordinate sets are measured from a zero reference point at a center of an exit plane of the gas turbine transition piece.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a gas turbine having a transition piece of a combustor, where the transition piece includes dilution holes;

FIG. 2 is a cross-sectional view of an embodiment of a combustor having a transition piece with dilution holes;

FIG. 3 is a top view of an embodiment of the transition piece of FIG. 2;

FIG. 4 is a side view of an embodiment of the transition piece of FIG. 2;

FIG. 5 is a bottom view of an embodiment of the transition piece of FIG. 2;

FIG. 6 is a side view (e.g., opposite the side view of FIG. 4) of an embodiment of the transition piece of FIG. 2;

FIG. 7 is an end view (e.g., forward end) of an embodiment of the transition piece of FIG. 2; and

FIG. 8 is an end view (e.g., aft end) of an embodiment of the transition piece of FIG. 2.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed towards a pattern of dilution holes formed in a transition piece of a gas turbine combustor to reduce emissions, while providing an exit boundary condition that is not detrimental to the durability of the turbine components of the gas turbine. In certain embodiments, the transition piece includes a first set of dilution holes formed in a forward end (e.g., having a straight portion) of the transition piece and a second set of dilution holes formed in an aft end of the transition piece. The first set of dilution holes is arranged in a pattern to reduce emissions to meet emissions regulations. For example, the pattern of the first set of dilution holes may reduce nitrogen oxide (NOₓ) levels to approximately less than 5 parts per million (ppm) and carbon monoxide (CO) levels to approximately less than 25 ppm. Also, the first set of dilution holes may include 3 dilution holes having a uniform diameter. The second set of dilution holes is arranged in a pattern to reduce a thermal gradient of a flow of combustion products to reduce thermal effects on downstream gas turbine components. Also, the second set of dilution holes may include 6 dilution holes, where some of the dilution holes of the second set have different diameters. The diameter of the second set of dilution holes may be designed to enable certain operating conditions (e.g., ambient temperature, combustor exit temperature, etc.). Together the first and second sets of dilution holes work together to reduce emissions without reducing the life of downstream turbine components.

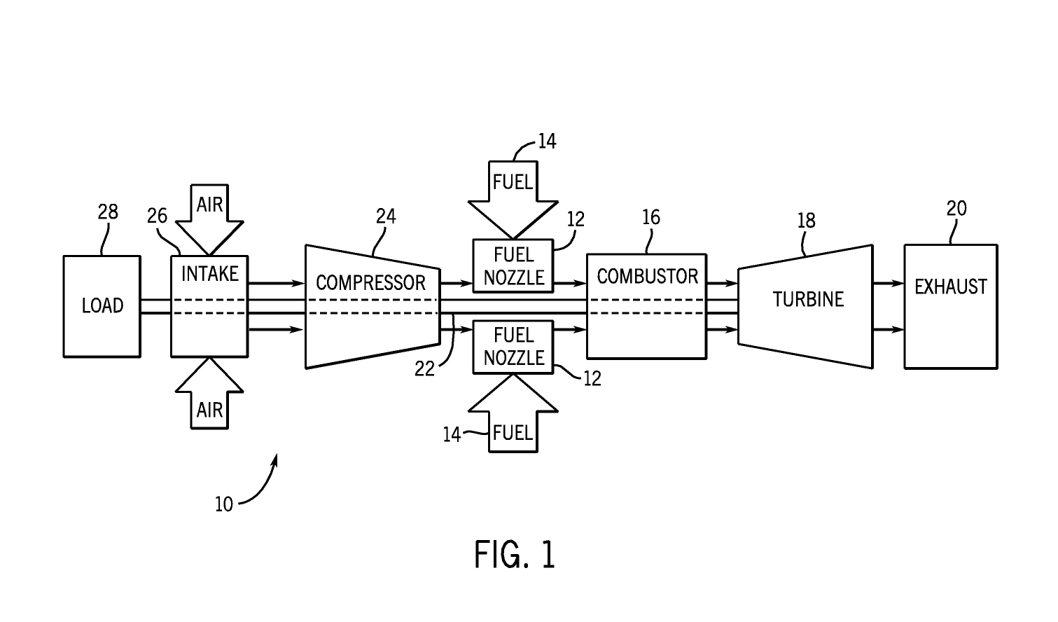

FIG. 1 is a block diagram of an embodiment of a turbine system 10 (e.g., gas turbine engine) having a combustor 16 that includes a transition piece with dilution holes, wherein a pattern of the dilution holes is configured to reduce emissions and to provide an exit boundary condition that is not detrimental to the durability of the turbine components of the gas turbine 10. For example, the turbine system 10 may be the 9E gas turbine (MS9001E) made by General Electric Company of Schenectady, N.Y. The turbine system 10 may use liquid or gas fuel to run the turbine system 10. Examples of fuel may include natural gas, hydrogen rich synthetic gas, propane, ethane, distillate (diesel) fuels, nitrogen-doped fuel sources, hydrogen-poor fuel sources (e.g., blast furnace gases), and/or any other fuel source for a turbine system 10. As depicted, a plurality of fuel nozzles 12 intakes a fuel supply 14, mixes the fuel with air, and distributes the air-fuel mixture into a combustor 16. In certain embodiments, the turbine system includes more than one combustor 16 (e.g., arranged in a can-annular array about a turbine rotor) each having a transition piece with dilution holes as described herein. The air-fuel mixture combusts in a chamber within combustor 16, thereby creating hot pressurized exhaust gases. The combustor 16 directs the exhaust gases through a turbine 18 toward an exhaust outlet 20. As the exhaust gases pass through the turbine 18, the gases force one or more turbine blades to rotate a shaft 22 along an axis of the system 10. As illustrated, the shaft 22 may be connected to various components of turbine system 10, including a compressor 24. The compressor 24 also includes blades that may be coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. As will be understood, the load 28 may include any suitable device capable of being powered by the rotational output of turbine system 10.

In operation, air enters the turbine system 10 through the air intake 26 and may be pressurized in the compressor 24. The compressed air may then be mixed with gas for combustion within combustor 16. For example, the fuel nozzles 12 may inject a fuel-air mixture into the combustor 16 in a suitable ratio for optimal combustion, emissions, fuel consumption, and power output. The combustion generates hot pressurized exhaust gases, which then drive one or more blades within the turbine 18 to rotate the shaft 22 and, thus, the compressor 24 and the load 28. The rotation of the turbine blades causes a rotation of shaft 22, thereby causing blades within the compressor 22 to draw in and pressurize the air received by the intake 26.

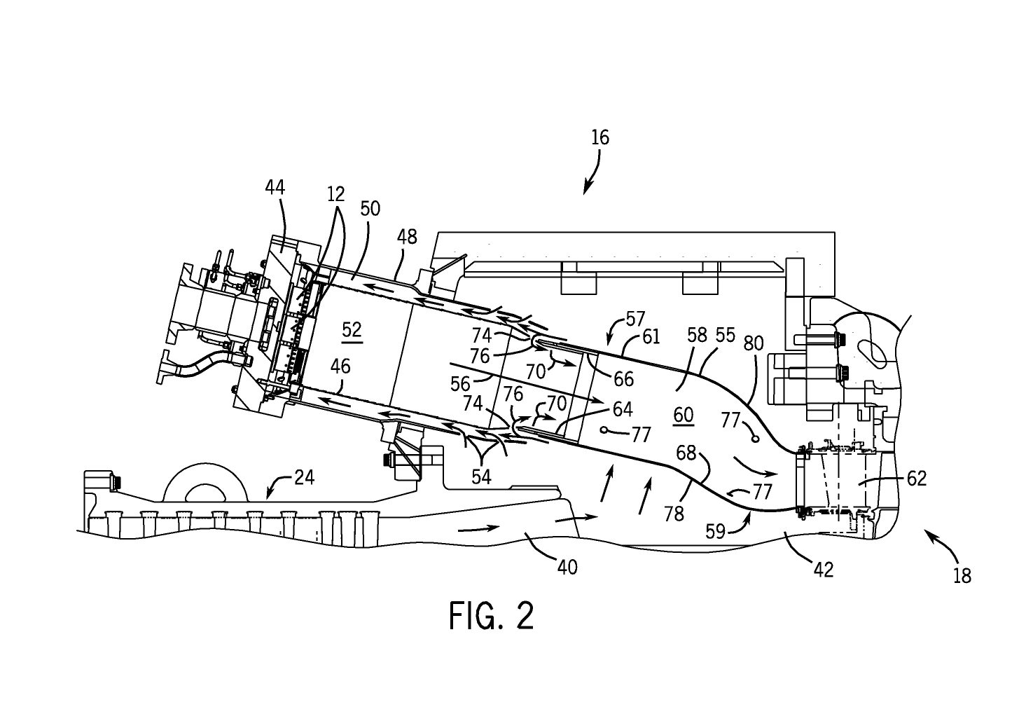

FIG. 2 is a partial cross-sectional view of an embodiment of the turbine system 10, illustrating details of the combustor 16 having a transition piece 58 with dilution holes. As will be appreciated, the combustor 16 is generally fluidly coupled to the compressor 24 and the turbine 18. The compressor 24 may include a diffuser 40 and a discharge plenum 42 that are coupled to each other in fluid communication to facilitate the channeling of compressed air to the combustor 16. In the illustrated embodiment, the combustor 16 includes a cover plate 44 at the upstream head end of the combustor 16. The cover plate 44 may at least partially support the fuel nozzles 12 and provide a path through which air and fuel are directed to the fuel nozzles 12.

The combustor 16 includes a combustor liner 46 disposed within a flow sleeve 48. The arrangement of the liner 46 and the flow sleeve 48, as shown in FIG. 2, is generally concentric and may define an annular passage 50. In certain embodiments, the flow sleeve 48 and the liner 46 may define a first or upstream hollow annular wall of the combustor 16. The interior of the liner 46 may define a substantially cylindrical, annular, oval, or closed-loop combustion chamber 52. The flow sleeve 48 may include a plurality of inlets 54, which provide a flow path for at least a portion of the air from the compressor 24 into the annular passage 50. In other words, the flow sleeve 48 may be perforated with a pattern of openings to define a perforated annular wall.

As used herein, the terms “upstream” and “downstream” shall be understood to relate to the flow of combustion gases inside the combustor 16. For example, a “downstream” direction refers to the direction 56 in which a fuel-air mixture combusts and flows from the fuel nozzles 12 through a transition piece 58 (e.g., gas turbine transition piece) towards the turbine 18, and an “upstream” direction refers to a direction opposite the downstream direction, as defined above.

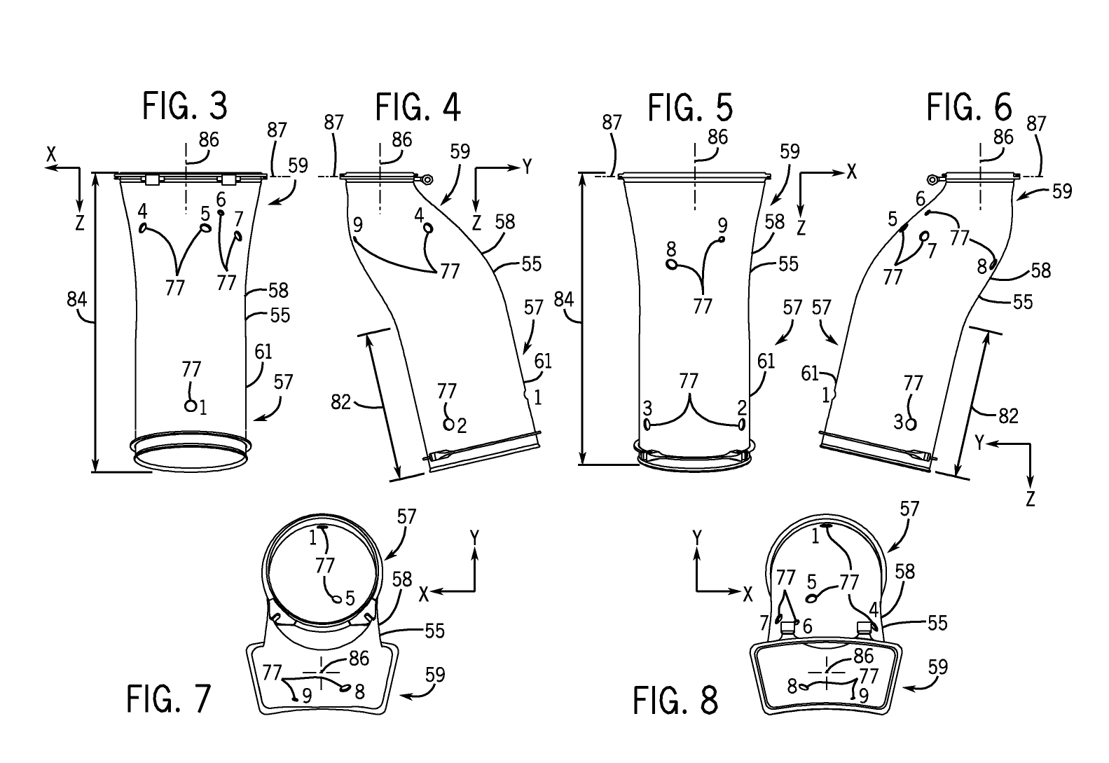

The transition piece 58 includes a duct body 55 having a forward end 57 (e.g., forward end portion) and an aft end 59 (e.g., aft end portion). As depicted, the forward end 57 includes a straight portion 61 that extends in the downstream direction 56 of the flow. In certain embodiments, a length 82 of the straight portion 61 may account for approximately 35 to 65 percent, 35 to 50 percent, 50 to 65 percent, and any other subrange therebetween, of a total length 84 of the transition piece 58 (see FIGS. 3-6). For example, the length 82 of the straight portion 61 may account for approximately 35, 40, 45, 50, 55, 60, or 65 percent, or any other percent of the total length 84 of the transition piece 58. In certain embodiments, the total length of the transition piece 58 may range from approximately 50.8 cm (20 in.) to 1.27 m (50 in.). For example, the total length of the transition piece 58 may be 1.016 m (40 in).

The duct body 55 defines an enclosure or interior cavity 60 for confining to routing a flow of combustion products. In particular, the interior cavity 60 of the transition piece 58 generally provides a path by which combustion gases from the combustion chamber 52 may be directed through a turbine nozzle 62 (e.g., first stage turbine nozzle) and into the turbine 18. In the depicted embodiment, the transition piece 58 may be coupled to the downstream end of the liner 46 (with respect to direction 56), generally about a downstream end portion 64 (coupling portion). An annular wrapper 66 and a seal may be disposed between the downstream end portion 64 and the forward end 57 of the transition piece 58. The seal may secure the outer surface of the wrapper 66 to the inner surface 68 of the transition piece 58. Further, as mentioned above, the inner surface of the wrapper 66 may define passages that receive a portion of the airflow from the diffuser 40.

As discussed above, the turbine system 10, in operation, may intake air through the air intake 26. The compressor 24, which is driven by the shaft 22, rotates and compresses the air. The compressed air is discharged into the diffuser 40, as indicated by the arrows shown in FIG. 2. The majority of the compressed air is further discharged from the compressor 24, by way of the diffuser 40, through a plenum 42 into the combustor 16. The air in the annular passage 50 is then channeled upstream (e.g., in the direction of fuel nozzles 12) such that the air flows over the transition piece 58 and the downstream end portion 64 of the liner 46. In the illustrated embodiment, the airflow provides forced convection cooling of the transition piece 58 and the liner 46. In certain embodiments, the downstream end portion 64 of the liner 46 may include a plurality of film cooling holes to provide a film cooling flow 70 and/or by-pass openings 74 to provide a cooling flow 76 into the combustion chamber 52. The remaining airflow in the annular passage 50 is then channeled upstream towards the fuel nozzles 12, wherein the air is mixed with fuel 14 and ignited within the combustion chamber 52. The resulting combustion gases are channeled from the chamber 52 into the transition piece cavity 60 and through the turbine nozzle 62 to the turbine 18.

As discussed above, the hot combustion gases flow from the combustor 16 through the transition piece 58 to the turbine 18. The transition piece 58 includes dilution holes 77 arranged in a particular pattern to reduce emissions and to provide an exit boundary condition that is not detrimental to the durability of the turbine components of the gas turbine 10. The location, number, and size of the dilution holes 77 are described in greater detail below. In particular, the forward end 57 includes a first set of dilution holes 77 arranged in pattern to reduce emissions. For example, the pattern of the dilution holes 77 in the forward end 57 may reduce nitrogen oxide (NOₓ) levels to approximately less than 5 parts per million (ppm) and carbon monoxide (CO) levels to approximately less than 25 ppm. In certain embodiments, the forward end 57 may include 3 dilution holes 77 (see Table 1, holes 1-3). Also, the aft end 59 includes a second set of dilution holes 77 arranged in a pattern to alter the thermal gradient of the flow of the combustion products in the downstream direction 56. By altering the thermal gradient of the flow, the pattern of the dilution holes 77 in the aft end 59 enables an exit boundary condition that is not detrimental to the durability of the turbine components of the gas turbine 10. In certain embodiments, the aft end 59 may include 6 dilution holes 77 (see Table 1, holes 4-9).

The air entering the discharge plenum 42 first contacts the transition piece 58 on a first portion 78 (e.g., radially inward side facing incoming airflow). After contacting the first portion 78 of the transition piece 58, the air wraps around the transition piece 58 and flows towards the second portion 80 (e.g., radially outward side facing away from the incoming airflow). A portion of air enters each of dilution holes 77 formed in the forward and aft ends 57, 59 of the duct body 55. The dilution holes 77 are formed in a direction normal to the surface of the duct body 55. Thus, jets of air flowing into the dilution holes 77 are generally directed toward a central axis of the flow of the combustion products. The size of the dilution holes 77 determines the penetration of the dilution air jets flowing into the flow of the combustion products. Together the first and second sets of transition holes 77 work together to reduce emissions without reducing the life of downstream turbine components.

FIGS. 3-8 illustrate the unique arrangement of the dilution holes 77 formed in the duct body 55 of the transition piece 58. The number, size, and location of the dilution holes 77 reduce emissions and provide an exit boundary condition that is not detrimental to the durability of the turbine components of the gas turbine 10. As described above in FIG. 2, the transition piece 58 includes the duct body 55 having the forward end 57 and the aft end 59. The duct body 55 defines the enclosure 60 for confining the flow of combustion products from the combustor 16 to the turbine first stage nozzle 62. Also, the forward portion 57 includes the straight portion 61 as described above. In certain embodiments, the length 82 of the straight portion 61 may account for approximately 35 to 65 percent, 35 to 50 percent, 50 to 65 percent, and any other subrange therebetween, of the total length 84 of the transition piece 58 (see FIGS. 3-6). For example, the length 82 of the straight portion 61 may account for approximately 35, 40, 45, 50, 55, 60, or 65 percent, or any other percent of the total length 84 of the transition piece 58. As depicted, the cross-sectional shape of the duct body 55 varies from a substantially elliptical shape at the front end 57 to an arched trapezoidal shape or a segmented annular shape at the aft end 59.

The dilution holes 77 (labeled 1-9 in FIGS. 3-8) are formed in the transition piece 58, located precisely along and about the duct body 55 as measured in inches (centimeters) along X, Y, and Z coordinates, from an origin or zero reference point 86 located at a center of the transition piece 58 (or duct body 55) exit plane 87 adjacent the aft end 59. The Z coordinate extends from the origin 86 in an upstream direction, i.e., in a direction opposite the flow through the transition piece 58. As illustrated, the transition piece 58 includes 9 dilution holes 77 formed in the duct body 55 (3 dilution holes 77 in the forward end 57 and 6 dilution holes 77 in the aft end 59). The X, Y, and Z coordinates of the location for each of the dilution holes 77 with respect to the origin 86 are set out in Table 1 below.

TABLE 1

| Hole | X | Y | Z |
|---|---|---|---|
| 1 | 0.00 (0.00) | 19.77 (50.2) | 31.33 (79.6) |
| 2 | 6.42 (16.3) | 8.93 (22.7) | 33.83 (85.9) |
| 3 | −6.42 (−16.3) | 8.93 (22.7) | 33.83 (85.9) |
| 4 | 6.48 (16.5) | 6.19 (15.7) | 7.40 (18.8) |
| 5 | −2.00 (−5.1) | 9.96 (25.3) | 7.40 (18.8) |
| 6 | −4.05 (−10.3) | 6.75 (17.1) | 5.35 (13.6) |
| 7 | −6.39 (−16.2) | 7.20 (18.3) | 8.50 (21.6) |
| 8 | −3.09 (−7.8) | −2.11 (−5.4) | 12.32 (31.3) |
| 9 | 3.67 (9.3) | −3.63 (−9.2) | 8.95 (22.7) |

In certain embodiments, the transition piece 58 may include 1 to 9 dilution holes 77 formed in the duct body 55 at any of the 9 locations defined in Table 1. For example, the transition piece 58 may include 3 dilution holes 77 formed in the forward end 57 of the duct body 55 (e.g., holes 1-3) and/or 6 dilution holes 77 formed in the aft end 59 of the duct body 55 (e.g., holes 4-9). The diameter of the dilution holes 77 may range from approximately 0.3 in. (0.8 cm) to 1.75 in. (4.4 cm). The effective open surface area of the dilution holes 77 may range from approximately 0.15 sq. in. (0.4 cm) to 3.5 sq. in. (8.9 cm). In certain embodiments, the dilution holes 77 formed in the forward end 57 may include a uniform diameter and/or uniform effective open surface area. For the example, dilution holes 77 formed in the forward end 57 may include a uniform diameter of approximately 1.3 in. (3.3 cm) and/or a uniform effective open surface area of approximately 3.2 sq. in. (8.1 cm). Some and/or all of the dilution holes 77 formed in the aft end 59 may have different diameters. For example, the diameter of holes 4-9 (e.g., formed in the aft end 59) may be approximately 0.74 (1.9), 0.8 (2), 0.6 (1.5), 0.74 (1.9), 0.817 (2.1), and 0.534 (1.4) in. (cm), respectively. The effective open surface area of holes 4-9 (e.g., formed in the aft end 59) may be approximately 0.354 (0.9), 0.412 (1), 0.231 (0.6), 0.354 (0.9), 0.430 (1.1), and 0.18 (0.5) sq. in. (cm), respectively.

Technical effects of the disclosed embodiments include providing a pattern of dilution holes formed in the transition piece 58 of the gas turbine combustor 16 to reduce emissions, while providing an exit boundary condition that is not detrimental to the durability of the turbine components of the gas turbine 10. In certain embodiments, the transition piece 58 includes a first set of dilution holes 77 formed in the forward end 57 (e.g., having a straight portion 71) of the transition piece 58 and a second set of dilution holes 77 formed in the aft end 59 of the transition piece 58. Together the first and second sets of dilution holes 77 work together to reduce emissions without impacting the life of downstream turbine components. In addition, installing the transition piece 58 with the dilution holes 77 into an existing gas turbine 10 reduces emissions levels at the fraction of a cost of purchasing a new gas turbine 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas turbine transition piece, comprising:
a duct body having a forward end portion and an aft end portion, wherein the duct body defines an enclosure for routing a flow of combustion products from a combustor to a turbine first stage nozzle, and the forward end portion comprises a straight portion extending in a downstream direction of the flow; and
a first set of dilution holes formed in the forward end portion and arranged in a first pattern configured to reduce emissions.

2. The system of claim 1, wherein the first set of dilution holes comprises 3 dilution holes.

3. The system of claim 2, wherein the 3 dilution holes are formed in the duct body at locations defined by selected X, Y, and Z coordinate sets listed in Table 1, wherein the coordinate sets are measured from a zero reference point at a center of an exit plane of the gas turbine transition piece.

4. The system of claim 1, wherein the first set of dilution holes have uniform diameters.

5. The system of claim 1, wherein the first pattern of the first set of dilution holes is configured to reduce NOₓ levels to approximately less than 5 parts per million (ppm) and CO levels to approximately less than 25 ppm.

6. The system of claim 1, wherein gas turbine transition piece comprises a second set of dilution holes disposed in the aft end portion and arranged in a second pattern configured to alter a thermal gradient of the flow.

7. The system of claim 6, wherein the second set of dilution holes comprises 6 dilution holes.

8. The system of claim 7, wherein the 6 dilution holes are formed in the duct body at locations defined by selected X, Y, and Z coordinate sets listed in Table 1, wherein the coordinate sets are measured from a zero reference point at a center of an exit plane of the gas turbine transition piece.

9. The system of claim 6, wherein at least some of the second set of dilution holes have different diameters.

10. The system of claim 6, wherein at least some of the dilution holes of both the first and second sets of dilution holes are formed in the duct body at locations defined by selected X, Y, and Z coordinate sets listed in Table 1, wherein the coordinate sets are measured from a zero reference point at a center of an exit plane of the gas turbine transition piece.

11. The system of claim 6, wherein the first set of dilution holes comprises 3 dilution holes and the second set of dilution holes comprises 6 dilution holes, and the first and second sets of dilution holes are formed in the duct body at locations defined by selected X, Y, and Z coordinate sets listed in Table 1, wherein the coordinate sets are measured from a zero reference point at a center of an exit plane of the gas turbine transition piece.

12. The system of claim 1, comprising a gas turbine engine having the gas turbine transition piece.

13. A system, comprising:
a gas turbine transition piece, comprising:
a duct body having a forward end portion and an aft end portion, wherein the duct body defines an enclosure for routing a flow of combustion products from a combustor to a turbine first stage nozzle;
a first set of dilution holes formed in the forward end portion and arranged in a first pattern configured to reduce emissions; and
a second set of dilution holes formed in the aft end portion and arranged in a second pattern configured to alter a thermal gradient of the flow,
wherein at least some of the dilution holes of both the first and second sets of dilution holes are formed in the duct body at locations defined by selected X, Y, and Z coordinate sets listed in Table 1, wherein the coordinate sets are measured from a zero reference point at a center of an exit plane of the gas turbine transition piece.

14. The system of claim 13, wherein the first set of dilution holes comprises 3 dilution holes formed in the duct body at the locations defined by the selected X, Y, and Z coordinate sets listed in Table 1.

15. The system of claim 13, wherein the first set of dilution holes have uniform diameters.

16. The system of claim 13, wherein the first pattern of the first set of dilution holes is configured to reduce NOₓ levels to approximately less than 5 parts per million (ppm) and CO levels to approximately less than 25 ppm.

17. The system of claim 13, wherein the second set of dilution holes comprises 6 dilution holes formed in the duct body at the locations defined by the selected X, Y, and Z coordinate sets listed in Table 1.

18. The system of claim 13, wherein at least some of the second set of dilution holes have different diameters.

19. The system of claim 13, wherein the first set of dilution holes comprises 3 dilution holes and the second set of dilution holes comprises 6 dilution holes, and the first and second sets of dilution holes are formed in the duct body at the locations defined by the selected X, Y, and Z coordinate sets listed in Table 1.

20. A system, comprising:
a gas turbine transition piece, comprising:
a duct body having a forward end portion and an aft end portion, wherein the duct body defines an enclosure for routing a flow of combustion products from a combustor to a turbine first stage nozzle;
a first set of dilution holes formed in the forward end portion and arranged in a first pattern configured to reduce emissions; and
a second set of dilution holes formed in the aft end portion and arranged in a second pattern configured to alter a thermal gradient of the flow,
wherein the first set of dilution holes comprises 3 dilution holes and the second set of dilution holes comprises 6 dilution holes, and the first and second sets of dilution holes are formed in the duct body at locations defined by selected X, Y, and Z coordinate sets listed in Table 1, wherein the coordinate sets are measured from a zero reference point at a center of an exit plane of the gas turbine transition piece.
